(19) United States
(12) Patent Application Publication
(10) Pub. No.: US 2004/0076847 A1
(43) Pub. Date: Apr. 22, 2004

(54) Colored wood/polymer composites

(76) Inventors: Howard E. Saunders JR., Scotch Plains, NJ (US); Charles B. Rybny, Doylestown, PA (US); Bruce J. Berman, Doylestown, PA (US)

Correspondence Address: MARVIN TURKEN, Jordan and Hamburg LLP, 122 East 42nd Street, New York, NY, 10168, US

(21) Appl. No.: 10/273,039

(22) Filed: Oct. 17, 2002

(51) Int. Cl. B32B 5/16

(52) U.S. Cl. 428/535; 428/323

(57) ABSTRACT

A colored polymer/wood composite, e.g., plastic lumber, formed by shaping a blend of a thermoplastic polymer and wood particles, e.g., wood flour, which has been colored by mixing with an aqueous dispersion of a pigment or an aqueous solution of a dye as a pretreatment, so that the pigment particles or dye are thoroughly absorbed into the fiber matrix of the wood particles, followed by drying. Preferably, the foregoing pigment dispersion or dye solution used to pretreat the wood particles also contains an effective amount of at least one member selected from the group consisting of light stabilizers, U.V. absorbers, antimicrobial agents including biocides, and antioxidants. The composite has a reduced tendency to fade or whiten with time.

### BACKGROUND OF THE INVENTION

1. Field of the Invention

This invention relates to colored wood/polymer composites, e.g., plastic lumber, having improved resistance to fading and whitening.

2. Background Information Including Description of Related Art

A polymer/wood composite, e.g., plastic lumber, is a composite of wood particles, e.g., wood flour, in a matrix comprising a major proportion of a polymer (or resin), generally a high molecular weight thermoplastic synthetic polymer, which is formed, as by extrusion or molding, into various shapes depending on the intended class of end use articles. The product has found wide acceptance in recent years as a substitute for ordinary lumber or other structural materials in a variety of end uses such as decking, fencing, railing, structural members for construction elements such as windows, doors, roofing and siding, including shingles, etc.

For many of the suitable end use applications of wood/polymer composites there is a demand for colored or distinct from natural appearing articles. A problem in satisfying this demand is that the colored wood/polymer composite has a tendency to fade or whiten after a relatively short period. Thus, any expedient which has the effect of eliminating or alleviating the problem of rapid fading or whitening of colored wood/polymer composites, is very desirable.

U.S. Pat. No. 4,168,251 issued Sep. 18, 1979 to Schinzel et al., discloses insulating material comprising polyvinyl chloride and a natural cellulosic material which is preferably wood meal. The composition may also contain additives such as colorants, stabilizers and antioxidants.

U.S. Pat. No. 5,486,553 issued Jan. 23, 1996 to Deaner et al., teaches polymer and wood composite structural members, e.g., for the assembly of windows and doors, formed by extruding and molding a composition comprising polyvinyl chloride and wood fiber such as wood flour. The composition may contain conventional additives such as thermal stabilizers, organic and inorganic pigments, and biocides.

U.S. patent application Publication Ser. No. 2001/0,019,749 of Godavarti et al., published Sep. 6, 2001, discloses a structural member used, e.g., for the manufacture of windows and doors made of a composite comprising a polyolefin polymer such as polypropylene, and a wood fiber, e.g., sawdust or mill toilings. Also contemplated as part of the composition are any of various pigment colorants, U.V. stabilizers, and antioxidants.

U.S. patent application Publication Ser. No. 2002/0,040,557 of Felton, published Apr. 11, 2002, discloses a composite panel for use in construction, particularly shingling, comprising a natural fiber, e.g., wood flour, and a polymer, e.g., polyethylene or polypropylene. The composite may also contain a U.V. stabilizer, a pigment, e.g., an inorganic metal oxide, and a fungicide.

Japanese Patent JP405261708A, published Oct. 12, 1993, discloses wood flour having the characteristics and functions of pigment particles and prepared by grinding wood flour between grinding balls by friction action to obtain wood flour enhanced in bulk density, and bonding pigment particles to the surfaces of the wood flour particles. The abstract does not indicate how the bonding is accomplished.

Japanese Patent JP406257259A, published Sep. 13, 1994, discloses the production of a rain gutter having woody patterns by first grinding coarse wood flour to obtain more finely divided particles, mixing the fine wood flour with a white pigment such as titanium dioxide, subjecting the mixture to additional grinding, mixing the fine wood flour containing pigment with fused vinyl chloride resin and solidifying the mixture to obtain colored pellets, and extruding the colored pellets with unfused and uncolored vinyl chloride resin to obtain a cylindrical or semi-cylindrical rain gutter having a pattern similar to the grain of wood.

### BRIEF SUMMARY OF THE INVENTION

In accordance with one aspect of the invention, a colored composite of a thermoplastic polymer (or resin) and wood particles, prepared by shaping as by extrusion or molding, a blend of such molten polymer with wood particles, e.g., wood flour, which have been colored by mixing with an aqueous dispersion of a pigment colorant or an aqueous solution of a dye colorant as a pretreatment, so that the colorant is thoroughly absorbed into the fiber matrix of the wood particles, followed by drying.

The colorant containing medium for the coloring pretreatment of the wood particles is either an aqueous dispersion of an inorganic or organic pigment or an aqueous solution of a suitable dye having some water solubility, and the degree of mixing of the wood particles and the colorant containing medium is generally such that the color of the pretreated wood particles appears substantially homogeneous.

Preferably, and in accordance with another aspect of the invention, the foregoing colorant dispersion or solution used to pretreat the wood also contains an effective amount of at least one member selected from the group consisting of light stabilizers, U.V. absorbers, antimicrobial agents including biocides, and antioxidants.

It has been found that colored wood/polymer composites formed in accordance with the invention tend to fade or whiten at a significantly slower rate than composites formed by blending the polymer with wood particles which have not been subjected to the described coloring pretreatment.

### DETAILED DESCRIPTION OF THE INVENTION

The wood particles used to form the colored wood/polymer composites of this invention may be any of various types of overlapping particle size ranges, e.g., wood flour, wood meal, or sawdust, in which the size of particles making up a major proportion of the weight of the particulate wood mass range from about 30 to about 3000 microns. Preferably, the wood particles are in the form of wood flour, in which the particles making up a major proportion of the weight of the mass have a size in the range of about 30 to about 600 microns.

Wood particles from substantially any type of wood may be used for this invention, including soft or hard wood from deciduous or evergreen, e.g. conifer, trees.

The pigment or dye used to pretreat the wood particles may be, for example, any of those with acceptable lightfastness which are compatible with such particles in wood/polymer composites, examples of which disclosed in U.S. patents and published patent applications cited previously, and the relevant disclosures of pigments in these references are hereby incorporated herein by reference. The dyes suitable for coloring wood particles under this invention are generally known to be effective with cellulosic materials, and dyeing procedures may be used which are well known in the art. Particularly suitable colorants are mixed metal oxide pigments such as red iron oxide and manganese antimony titanate, and organic pigments such as phthalocyanine blue. In the case of pigments, the major proportion of the particles may have a size in the range, for example, of about 0.1 micron to about 50 microns. The amount of pigment in the aqueous dispersion used to pretreat the wood particles may be in the range, for example, of about 0.1 to about 80 wt. % based on the total weight of the composition, and the concentration of contemplated dye solutions is within the ranges known in the art for dyeing any material. Colorant preparations for the wood flour may be prepared by diluting dispersions which are commercially available and suitable pigment dispersions or dye solutions may contain adjuvants such as thickeners, surfactants, etc., which impart stability and other desirable properties to the dispersion or solution.

The colored wood particles are prepared by thoroughly mixing the wood particles with the aqueous colorant dispersion or solution in quantities such that the amount of pigment is, for example, about 0.1 to about 100 wt. % based on the weight of the wood particles, and the amount of dye, if used, is within the ranges known in the art, based on the weight of the materials being dyed. The mixing is continued until substantially all of the liquid has been absorbed into the matrix of fibers making up the wood particles. The colored wood particles are then heated to a temperature, e.g., of about 120 to about 225° F., for a period, e.g., of about 20 to about 120 minutes until the moisture content is substantially reduced, e.g., to below 10% and preferably to about 2%. The wood particles are then cooled, e.g., to 100° F. or below prior to blending with a suitable thermoplastic polymer. Vacuum may be used to expedite the removal of water.

The blending of colored wood particles prepared as described previously with a thermoplastic polymer has been found to yield wood/polymer composites, e.g., plastic lumber, which have a much lower rate of fading or whitening than composites prepared by more conventional dry blending of wood particles, thermoplastic polymer and colorant. However, an even lower rate of fading or whitening has been found to result when at least one member selected from the group consisting of light stabilizers, U.V. absorbers, antimicrobial agents including biocides, and antioxidants, is added to the aqueous colorant dispersion or solution which is mixed thoroughly with the wood particles. These additives may be any of those known in the art which are compatible with the thermoplastic polymers and wood particles contemplated in the compositions of this invention. The light stabilizer, if added, may be, for example, a hindered amine (HALS) present in the dispersion in an amount, for example of about 1.0 to about 3.0 wt. % based on the total weight of the dispersion; the U.V. absorber, if added, may be, for example, a benzotriazole derivative or benzophenone derivative present in the dispersion in an amount, for example, of about 2.0 to about 10.0 wt. %; the antimicrobial agent or biocide, if added, may be, for example, any of various bactericides or fungicides known in the art and may be present in the dispersion or solution in an amount, for example, of about 0.5 to about 2.0 wt. %; and the antioxidant, if added, may be present in the dispersion in an amount, for example, of about 0.1 to about 3.0 wt. %. Preferably, amounts of all three of a light stabilizer, a U.V. absorber, and an antimicrobial agent or biocide are present in the aqueous colorant dispersion or solution before it is used to color the wood particles.

The thermoplastic polymer blended with the colored wood particles prepared as described previously may be any polymer which is compatible with the colored wood particles of the invention and does not interfere with the desired properties of the wood/polymer composite to be made. Suitable polymers are those, for example, disclosed in the U.S. patents and published patent applications cited previously as compatible with wood or other forms of cellulose, and the relevant disclosures of such polymers are hereby incorporated herein by reference. The thermoplastic polymer is preferably polyvinyl chloride or a polyolefin such as polypropylene or high or low density polyethylene (HDPE or LDPE). Mixtures of polymers such as polyolefins may also be used.

The blending of colored wood particles and thermoplastic polymer is carried out by conventional means, as by thoroughly mixing molten polymer with the colored wood particles until a uniform blend is obtained. Also present in the blend, either premixed with the polymer prior to blending with the colored wood particles or added during the mixing, are any of various additives conventionally present in thermoplastic polymer compositions, such as light stabilizers, U.V. absorbers, and/or antimicrobial agents or biocides, thermal processing stabilizers, antioxidants, lubricants, impact modifiers, chemical foaming agents, flame retardants, compatibilizers, and nucleating agents. These latter additives present in the polymer prior to blending with the colored wood particles, or added during such blending, are independent of and generally remain separate from the additives present in the matrix of the colored wood particles before blending, due to the high viscosity of the molten polymer during blending which substantially prevents the additives present before or added during blending from penetrating the matrix of the wood particles. The blended compositions may contain, for example, about 35 to about 85 wt. %, preferably about 40 to about 60 wt. % of thermoplastic polymer, and about 15 to about 65 wt. %, preferably about 40 to about 60 wt. % of wood particles colored in accordance with this invention. The composition is in the form of a dispersion of the colored wood particles and any other solid particles, e.g., of additives, which may be present in a continuous polymer matrix. The molten composition obtained either directly from the compounding of the polymer and colored wood particles, or by remelting an intermediate solid form of the composition, e.g., pellets, is formed into shaped articles by conventional means, e.g., extrusion in the case of plastic lumber such as boards, or injection or compression molding in the case of articles having a more complex shape.

As will be shown hereinafter, there is less fading and whitening of shaped articles made from wood particles colored in accordance with this invention than occurs with colored polymer/wood composite shaped from blends prepared by more conventional means wherein the wood particles are not treated with an aqueous dispersion or solution of colorant. This is believed to be caused by the fact that thoroughly coating the wood particles with an aqueous dispersion or solution of colorant results in the colorant having much more thorough penetration into and contact with the fiber matrix of the wood particles, allowing the colorant to have a significantly greater effect in maintaining the color of the wood particles by competing for spectral radiation destructive to the wood particles and minimizing the whitening of the wood particles ordinarily caused by exposure to such U.V. and light rays, as well as to microbial activity, and/or oxidation.

As previously stated, an even greater effect in reduction of whitening and fading of the colored polymer/wood composite is achieved when at least one of a light stabilizer, U.V. absorber, antimicrobial agent or biocide, and/or antioxidant and preferably all three of light stabilizer, U.V. absorber, and antimicrobial agent or biocide, are present in the aqueous pigment dispersion or solution used to color the wood particles in accordance with the invention. This improvement is believed to occur because similar to the colorant, the presence of these agents in the aqueous colorant dispersion or solution used to color the wood particles causes a thorough penetration into and contact of these agents with the fiber matrix of the wood particles which lessens the whitening effect from U.V. and light rays, microbial activity and/or oxidation on the wood particles, in addition to the similar effect of the presence of the colorant itself on the wood particles.

The following examples further illustrate the invention.

### EXAMPLE 1

An aqueous dispersion of red iron oxide pigment was prepared by thoroughly mixing and dispersing ingredients using dispersion equipment known in the art, to yield a composition having the following formula wherein a major proportion of the red iron oxide has a particle size in the range of about 0.5 to about 12.5 microns.

| Component | Wt. % | |
|---|---|---|
| Red Iron Oxide | 40.0 | |
| Water reducible Acrylic Copolymer | 52.5 | |
| @ 25% solids in water | | |
| Propylene Glycol | 4.0 | |
| Dimethylethanolamine | 1.0 | |
| Bentone Clay Thixatrope with | 1.5 | |
| Polymeric rheology modifier | | |
| Defoamer | 1.0 | |
| Maximum particle size | 12.5 | microns |

| | |
|---|---|
| Total non-volatiles | 52.0 +/− 2 |

This pigment dispersion was further diluted prior to use to facilitate a more uniform absorption by the wood flour. To accomplish this, 28.1 Parts by weight of the foregoing dispersion is added to a properly sized mixing tank equipped with an agitator suitable for mixing the entire final mass in the tank, and agitation is started. 61.9 Parts by weight of water is then added to the tank at a rate slow enough to prevent flocculation of the predispersed pigment. This mass is then mixed for ten minutes or until uniform and then adjusted by the addition of up to 10 additional parts by weight of water to equal a preestablished standard for color strength. The mass is then mixed until uniform.

Wood flour, a major proportion of which has a particle size range of about 30 to about 600 microns is added slowly to a paddle blender equipped with a heating and cooling jacket. After the addition of wood flour is completed, an amount of diluted pigment dispersion is slowly charged to the blender containing the wood flour while jogging the paddle blender to avoid excessive dusting. Once the dusting stage is past, an additional amount of diluted dispersion is added as the blender is operating to obtain a composition containing about 44.2 wt. % of wood flour and about 55.8 wt. % of diluted dispersion. Mixing is continued until all of the liquids have been absorbed into the wood flour, which is now colored, and the color of the mixture appears completely homogenous. Steam is then applied to the jacket of the blender and the mixing is continued for about 45 minutes after a temperature of 140° F. has been reached. At this time, the moisture content is approximately 2 wt. %. Cooling water is then applied to the jacket and mixing is continued until the wood flour temperature reaches 100° F. Comparable mixtures have also been prepared using high speed Henschel blenders and mixers capable of blending liquid material thoroughly with dry powders.

Polyvinyl chloride homopolymer having an I.V. of 1.2-2.0, was then blended uniformly with the colored wood flour in approximately equal proportions of polymer and pigmented wood flour, with the mixture also containing thermal processing stabilizers and lubricants added with the polymer and separately added hindered amine light stabilizer and U.V. absorber such that the overall percentages of these components in the blend were equal to the percentages present in the final composition described hereinafter in Example 2. This blend was extruded into plastic lumber, which was subjected to xenon weatherometer testing at intervals of 500 hours until it failed at slightly less than 1000 hours.

### EXAMPLE 2

The procedure of Example 1 was followed, except that the initial red iron oxide dispersion before dilution was combined with stabilizer by mixing the following components in a high speed mixer.

| Composition | Wt. % |
|---|---|
| Initial Red Iron Oxide Dispersion | 89.0 |
| Hindered Amine Light Stabilizer [mixture of | 2.5 |
| bis (1,2,2,6,6-pentamethyl-4-piperidinyl) | |
| sebacate and methyl (1,2,2,6,6-pentamethyl-4- | |
| piperidinyl) sebacate] | |
| U.V. Absorber (hydroxyphenylbenzotriazole class) | 7.5 |
| Biocide (1,2-benzisothiazolin-3-one at 19% | 1.0 |
| Concentration) | |

Since substantially the same amounts of polymer, pigmented wood flour, light stabilizer, and U.V. absorber were used to prepare the colored wood/polymer composite of this example as that of Example 1, both compositions have substantially the same proportions of these components with the main difference in the compositions of the two examples being the presence of stabilizers and biocide in the aqueous pigment dispersion in this example.

The plastic lumber composite extruded from the composition of this example exhibited minimal and acceptable color change after three thousand hours of xenon exposure in the weatherometer.

### COMPARATIVE EXAMPLE A

A blend of undispersed pigment, wood flour, polyvinyl chloride, hindered amine light stabilizer, U.V. absorber and thermal processing stabilizer, of the same types and proportions as those in the blends of Examples 1 and 2, were conventionally dry blended and extruded into a plastic lumber composite. This product failed xenon weatherometer testing in somewhat less than 500 hours of exposure.

The substantial improvement in the result of xenon weatherometer testing of the plastic lumber composite of Example 1 over that of Comparative Example A shows the significant effect of precoloring wood flour with an aqueous dispersion of pigment, even in the absence of additional stabilizers in the dispersion, over the preparation of the composite by mere dry blending of wood flour, polymer, undispersed pigment and stabilizers. Moreover, the even greater improvement in the result of xenon weatherometer testing of the plastic lumber composite of Example 2 over that of both Example 1 and Comparative Example A indicates that the best method of preparation among these examples includes the coloring of the wood flour with an aqueous pigment dispersion which also contains any of certain stabilizers and a biocide.

1. A composition comprising a thermoplastic polymer and wood particles which have been colored by mixing them with an aqueous dispersion of a pigment or an aqueous solution of a dye such that the pigment particles or dye are thoroughly absorbed into the fiber matrix of the wood particles.

2. The composition of claim 1 wherein said aqueous dispersion or solution also contains at least one member selected from the group consisting of light stabilizers, U.V. absorbers, antimicrobial agents, and antioxidants.

3. The composition of claim 2 wherein said aqueous dispersion or solution contains a light stabilizer, a U.V. absorber and an antimicrobial agent.

4. The composition of claim 1 wherein said polymer is polyvinyl chloride.

5. The composition of claim 1 wherein said polymer is a polyolefin.

6. The composition of claim 5 wherein said polyolefin is polyethylene.

7. The composition of claim 5 wherein said polyolefin is polypropylene.

8. The composition of claim 1 wherein said wood particles are wood flour.

9. Colored wood particles prepared by mixing said wood particles with an aqueous dispersion of a pigment or an aqueous solution of a dye such that the pigment particles or dye are thoroughly absorbed into the fiber matrix of the wood particles.

10. The wood particles of claim 9 wherein said aqueous dispersion or solution also contains at least one member selected from the group consisting of light stabilizers, U.V. absorbers, antimicrobial agents, and antioxidants.

11. The wood particles of claim 9 wherein said aqueous dispersion contains a light stabilizer, a U.V. absorber, and an antimicrobial agent.

12. The wood particles of claim 9 which are wood flour.

13. A process for preparing colored wood particles comprising mixing said wood particles with an aqueous dispersion of a pigment or an aqueous solution of a dye such that the pigment particles or dye are thoroughly absorbed into the fiber matrix of the wood particles.

14. The process of claim 13 wherein said aqueous dispersion or solution also contains at least one member selected from the group consisting of light stabilizers, U.V. absorbers, antimicrobial agents, and antioxidants.

15. The process of claim 4 wherein said aqueous dispersion or solution contains a light stabilizer, a U.V. absorber and an antimicrobial agent.

16. A colored polymer/wood composite formed by shaping the composition of claim 1.

17. The composite of claim 16 wherein said aqueous dispersion or solution also contains at least one member selected from the group consisting of light stabilizers, U.V. absorbers, antimicrobial agents, and antioxidants.

18. The composite of claim 17 wherein said aqueous dispersion or solution contains a light stabilizer, a U.V. absorber and an antimicrobial agent.

19. The composite of claim 16 which is plastic lumber formed by extruding said composition.

20. The composite of claim 18 which is plastic lumber formed by extruding said composition.
